(19) United States
(12) Patent Application Publication
(10) Pub. No.: US 2026/0212299 A1
(43) Pub. Date: Jul. 23, 2026

(54) WORKPLACE RISK QUANTIFICATION METHOD AND SYSTEM

(71) Applicant: BANQUE NATIONALE DU CANADA, Montréal (CA)

(72) Inventors: Jonathan MUBAYED, Montréal (CA); Jean GUIRGUIS, Montréal (CA); Virginie LAMONTAGNE, Montréal (CA); Catherine LIEPINS, Montréal (CA); Geneviève BARRETTE, Montréal (CA); Anne Marie BOURGEOIS, Montréal (CA)

(21) Appl. No.: 19/451,576

(22) Filed: Jan. 16, 2026

Related U.S. Application Data
(60) Provisional application No. 63/746,534, filed on Jan. 17, 2025.

(51) Int. Cl. G06Q 10/0635

(52) U.S. Cl. CPC G06Q 10/0635

(57) ABSTRACT

The present disclosure provides systems and methods providing measurable and comparable workplace risk assessments to enable targeted managerial interventions. Methods and systems for aggregating workplace-related features and generating a risk index using nonnegative matrix factorization (NMF) are disclosed. Unlike traditional statistical measures, the disclosed method automatically derives optimal weights for the features based on the data distribution, eliminating the need for manual weighting or simplifying assumptions. The disclosed systems and methods produce actionable metrics rather than abstract components, enabling more practical applications in workplace risk assessment, and can be more computational efficient than alternative methods. NMF is inherently explainable, as the non-negativity constraints ensure that the derived latent features and weights have clear, intuitive meanings. This transparency enhances the interpretability of the resulting risk indices and facilitates their practical application in workplace environments.

### CROSS-REFERENCE TO RELATED APPLICATION

This application claims the benefit of, and priority to, U.S. Provisional Ser. No. 63/746,534 , filed Jan. 17, 2025, and entitled “WORKPLACE RISK QUANTIFICATION METHOD AND SYSTEM”, the disclosure of which is hereby incorporated by reference in its entirety.

### TECHNICAL FIELD

The technical field relates to feature analysis using machine learning, and more specifically to systems and methods for providing measurable workplace risk assessments.

### BACKGROUND

Workplace environments involve a multitude of interconnected factors that influence team performance, employee well-being, and organizational outcomes. Assessing and managing risks in such environments typically requires aggregating workplace-related features into a meaningful risk index.

Traditional approaches often rely on central statistical measures, such as the mean or median, to represent aggregated features. While simple and computationally efficient, these methods require manual adjustments of the aggregation methodology to capture the non-linearity between workplace factors and their interrelationships, or assume uniform contributions from all features which can lead to oversimplified risk indices that fail to capture the nuanced relationships between workplace factors.

More sophisticated techniques, such as principal component analysis (PCA), address these limitations by reducing the dimensionality of data and identifying the principal components that explain the largest variance. However, PCA outputs are often abstract and lack actionable metrics, making them less practical for interpreting workplace risks. Moreover, PCA involves computationally intensive operations, such as eigenvalue decomposition, which can be resource-prohibitive for large datasets.

Machine learning models, including neural networks such as autoencoders, offer advanced capabilities for feature aggregation and prediction. However, many of these techniques often suffer from a lack of explainability, commonly referred to as the “black box” problem. This opacity hinders the interpretability of the results and complicates the process of extracting actionable insights from the generated risk indices. Moreover, some machine learning methods can demand significant computational resources.

### SUMMARY

The limitations discussed above highlight the need for methods that combine computational efficiency, actionable outputs, and model transparency to create interpretable and actionable workplace risk indices.

The present disclosure provides systems and methods providing measurable and comparable workplace risk assessments to enable targeted managerial interventions. Methods and systems for aggregating workplace-related features and generating a risk index using nonnegative matrix factorization (NMF) are disclosed. Unlike traditional statistical measures, the disclosed method automatically derives optimal weights for the features based on the data distribution, eliminating the need for manual weighting or simplifying assumptions.

Compared to PCA, the disclosed method produces actionable metrics rather than abstract components, enabling more practical applications in workplace risk assessment. Additionally, NMF avoids resource-intensive operations like eigenvalue decomposition and can therefore be more computationally efficient.

Unlike many machine learning models, NMF is inherently explainable, as the non-negativity constraints ensure that the derived latent features and weights have clear, intuitive meanings. This transparency enhances the interpretability of the resulting risk indices and facilitates their practical application in workplace environments.

The disclosed method also supports enhanced visualizations and interpretable outputs, providing clear insights into team dynamics and risk factors. By addressing the limitations of prior approaches, the proposed method offers a practical and effective solution for workplace risk management, optimizing both analytical accuracy and computational resource usage.

In accordance with an aspect, a computer-implemented method for providing measurable workplace risk assessments associated with a plurality of managers is provided. The method includes obtaining a plurality of values, each value associated with one feature from a plurality of workplace behaviour or assessment features and with one manager, wherein each feature is associated with one category from a plurality of risk assessment categories, computing a respective data matrix of a plurality of data matrices for each subset of features of the workplace behaviour or assessment features associated with each given category, the respective data matrix comprising a plurality of rows each corresponding to one manager and a plurality of columns each corresponding to one feature from the subset of features, and fitting a respective machine learning model of a plurality of machine learning models onto the data matrix for each data matrix associated with a respective category, the respective machine learning model comprising a respective coefficient matrix from a plurality of coefficient matrices and a respective component matrix from a plurality of component matrices. Each coefficient matrix is a nonnegative row vector, each component matrix is a nonnegative column vector, each machine learning model is fitted using non-negative matrix factorization, and each row of each component matrix is associated with a row of the data matrix corresponding to a respective manager and represents a risk index of the respective manager with respect to the respective category. The method further includes computing a plurality of category risk indices associated with each respective category and each manager, wherein each category risk index exists on a N-point ordinal scale, and wherein each category risk index is computed based on a respective component matrix value associated with a respective category and a respective manager, and N−1 thresholds, and computing a global risk index associated with each manager based on a central value of the category risk indices, wherein the global risk index quantifies the risk associated with the manager.

In accordance with another aspect, a system for providing measurable workplace risk assessments associated with a plurality of managers is provided. The system includes at least one datasource configured to obtain a plurality of values, each value associated with one feature from a plurality of workplace behaviour or assessment features and with one manager, wherein each feature is associated with one category from a plurality of risk assessment categories, a learning computer-implemented platform, a computer-implemented index computation platform, and a consultation device configured to display the visualizations. The learning computer-implemented platform is configured to compute a respective data matrix of a plurality of data matrices for each subset of features of the workplace behaviour or assessment features associated with each given category, the respective data matrix comprising a plurality of rows each corresponding to one manager and a plurality of columns each corresponding to one feature from the subset of features, fit a respective machine learning model of a plurality of machine learning models onto the data matrix for each data matrix associated with a respective category, the respective machine learning model comprising a respective coefficient matrix from a plurality of coefficient matrices and a respective component matrix from a plurality of component matrices. Each coefficient matrix is a nonnegative row vector, each component matrix is a nonnegative column vector, each machine learning model is fitted using non-negative matrix factorization, and each row of each component matrix is associated with a row of the data matrix corresponding to a respective manager and represents a risk index of the respective manager with respect to the respective category. The computer-implemented index computation platform is configured to compute a plurality of category risk indices associated with each respective category and each manager, wherein each category risk index exists on an n-point ordinal scale, and wherein each category risk index is computed based on a respective component matrix value associated with a respective category and a respective manager, and n-1 thresholds, computing a global risk index associated with each manager based on a central value of the category risk indices, wherein the global risk index quantifies the risk associated with the manager, and implement a visualization module configured to provide visualizations of the global risk index and the category risk indices. The consultation device is configured to display the visualizations.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1 is a schematic of a system for quantifying a risk associated with managers in accordance with an embodiment.

FIG. 2 is a flowchart of a method for quantifying a risk associated with managers in accordance with an embodiment.

FIGS. 3A to 3E illustrates different views of a graphical user interface in accordance with an embodiment.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practised without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

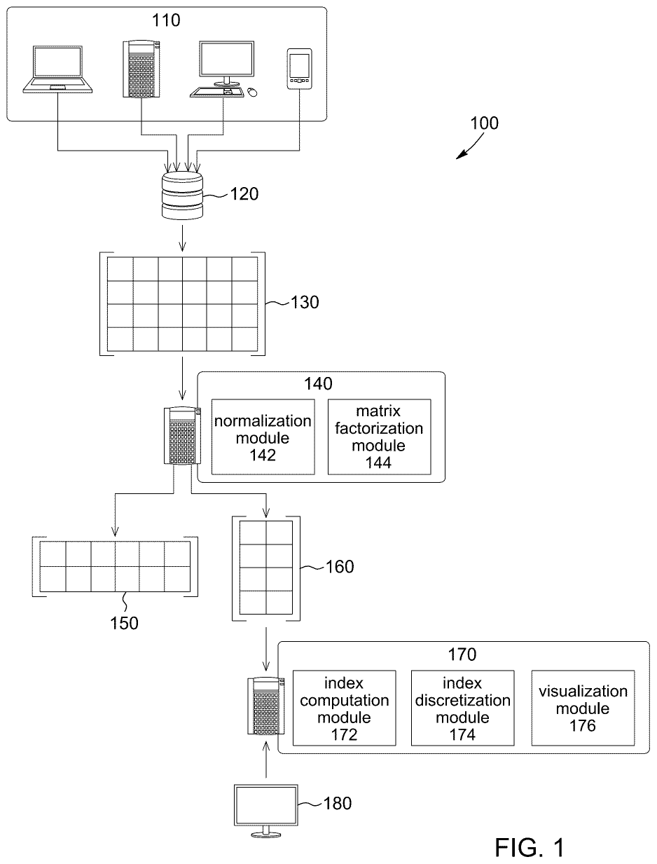

With reference to FIG. 1, an exemplary system 100 for quantifying a risk associated with managers of an organization is shown. This provides a measurable and comparable workplace risk assessment to enable targeted managerial interventions. In the present disclosure, a risk “associated with a manager” can indicate not necessarily that the risk is “posed” by the manager but rather that the risk is actionable by the manager. Broadly described, workplace data 120 is collected from a number of sources 110, from which insights such as performance indicators of managers can be computed. Selected indicators are extracted, e.g., as tabulated data such as a matrix 130, also called data matrix. A learning platform 140 is used to train a model 150, 160, from which an index computation platform 170 computes risk indices and provides visualizations for a consultation device 180.

The system 100 includes a number of sources 110 configured to acquire workplace data 120 configured to store the workplace date, e.g., in a storage module. The sources 110 can for instance include computing devices such as workstations, laptops and handheld devices used by employees and managers of the organization as well as servers implementing functions related as examples to human resource (HR) management or to cloud-based productivity suites.

In some embodiments, sources 110 include at least an employee experience platform configured to acquire at least a portion of the workplace data from employees, for instance through employee surveys, feedback tools, suggestion boxes, focus groups, the application of sentiment analysis tools to employee-created content and/or town hall Q&A sessions. Data 120 acquired through such sources can for instance include employee assessment of factors such as the manager, the team and/or the organization's vision, innovation, equity, environmental and social governance, collaboration, physical and/or technological environment, flexibility, performance management, wages and conditions, performance management and/or work-life balance, as well as the employee's sense of belonging and/or of performing significant work, the employee's feeling of autonomy, acknowledgement, personal and/or professional development and/or physical and psychological security.

In some embodiments, sources 110 include at least a workforce data repository, an HR management system, a payroll management system, and/or a digital, manual and/or punch card-based timekeeping system configured to acquire at least a portion of the workplace data. Data 120 acquired through such sources can for instance include employee profiles or records, e.g., including demographic and/or diversity data, such as for example the ethnicity, origin, disability status, gender, age of each employee, and/or other factors relevant to assessing and promoting diversity and inclusion within the organization, as well as information such as hiring date and history in the organization. Additionally or alternatively, data 120 acquired through such sources can for instance include time and attendance records, including information such as employee work hours, overtime, absences, vacation, personal and/or sick day usage, and/or leave balances.

In some embodiments, sources 110 include at least a workplace data integration platform and/or an enterprise API ecosystem, such as Microsoft™ Graph and/or Google Workspace™ API, configured to acquire at least a portion of the workplace data. Data 120 acquired through such sources can for instance include data aggregated or generated by analyzing information made available by employees or managers'use of productivity and/or collaboration software such as calendering applications and/or email applications. As examples, data 120 extracted from calendering applications and/or email applications can include indications of time spent in meetings and/or number of meetings, and/or of interactions and links with employees and/or managers of the organization, determined for instance based on exchanged emails and/or on meetings.

In some embodiments, the storage module can include a database optimized to enhance performance and support complex data modelling. Depending on the requirements of the system, various types of databases can be used, including but not limited to relational databases, graph databases, key-value stores, and document-oriented databases. Each type of database offers unique features and performance benefits suited for different data structures and use cases.

Relational databases, managed by relational database management systems (RDBMS) like MySQL™ or PostgreSQL™, organize data into tables with rows and columns. They can handle complex queries efficiently using SQL-based operations, making them suitable for applications requiring structured data and relationships. Operations within an RDBMS can include generating and executing SQL commands such as “INSERT” to add data, “UPDATE” to modify existing records, and “SELECT” to retrieve data. Relational databases can advantageously be used to offer high data integrity and transaction reliability.

Graph databases are designed to represent and query complex relationships between data points. Examples of graph databases include RDF stores and systems like Neo4j™. They store data in nodes and edges, making them particularly effective for scenarios involving intricate, interconnected data structures, such as social networks, recommendation engines, or permission structures. Graph databases often use specialized query languages, such as SPARQL or Cypher™, which allow efficient traversal of relationships within the data. By executing “INSERT” operations to add new nodes and edges or “SELECT” queries to retrieve connected data, graph databases enable fast and flexible relationship modelling.

Key-value stores, such as Redis™ and DynamoDB™, can provide a simple, schema-less storage solution where data is stored as key-value pairs. This structure supports rapid read and write operations, making key-value stores suitable for high-speed caching and real-time applications. In scenarios where data is accessed frequently but updated less often, key-value stores can improve performance by reducing latency. “GET” and “PUT” operations are commonly used to retrieve and update data in key-value databases, allowing applications to quickly access specific data points without the overhead of complex queries.

Document-oriented databases, like MongoDB™ and Couchbase™, store data in flexible, semi-structured documents, often in formats like JSON or BSON. This approach allows for the handling of unstructured or evolving data schemas, allowing for easy storage of nested data structures. Document databases support dynamic schemas, enabling developers to add new fields without restructuring the database. Queries within document stores often involve operations to search for documents based on specific criteria, making them highly adaptable for content management systems, e-commerce platforms, and other applications with diverse data types.

Performance optimizations implemented within these database systems can involve indexing strategies, caching mechanisms, and distributed storage architectures. Indexing can help improve query speed by organizing data in a way that allows for faster retrieval. For instance, in relational databases, creating indexes on frequently queried columns can significantly reduce search times. Similarly, graph databases can benefit from indexing on node properties to accelerate relationship-based queries. Caching mechanisms, which temporarily store frequently accessed data in volatile memory, help reduce database load and improve response times.

Distributed storage and sharding are additional strategies used in some embodiments to enhance database performance. By distributing data across multiple servers, databases can handle higher volumes of requests and improve redundancy. Sharding can involve dividing a database into smaller, more manageable pieces, allowing concurrent access to different data segments, which is particularly beneficial for high-traffic systems.

In implementing a database, considerations can also be given to data security and integrity. In some embodiments, encryption can be applied to sensitive data stored in the database, and access control mechanisms can regulate permissions to ensure that only authorized users can view or modify certain records. In cases where data privacy is desirable, databases may be configured to anonymize or redact sensitive information, particularly when handling personal or confidential data. Data consistency and fault tolerance can also help for maintaining database reliability, and techniques such as transactional support and backup mechanisms can ensure data integrity even in the event of hardware or software failures.

Workplace data 120 can be used as performance indicators for any given manager of the organization, aggregated as performance indicators, and/or used to derive performance indicators. As an example, when assessing a given manager, data 120 related to employees and/or managers working under the authority of the manager or belonging to the manager's team can be aggregated, e.g., averaged, to obtain a performance indicator applicable to the manager themselves. In some embodiments, at least a portion of data 120 is used to derive complex indicators. As an example only, attendance records related to employees in a team can be used to compute an attendance score of each employee such as a Bradford factor, which can then be aggregated to derive a performance indicator for a manager of the team. As another example, data obtained from a collaboration suite for a manager can be cross-refenced with attendance records related to the manager to derive indicators such as a proportion of the manager's work time spent in meetings, and/or with employee records of the persons they interact with to derive indicators such as a number of interactions with employees at a different organizational level.

Key performance indicators (KPIs) are selected to be used in data matrices 130, such that each line corresponds to a manager to be assessed and each column corresponds to a KPI used as a feature. In some embodiments, feature engineering additional or alternative to the techniques described above can be applied to make matrix 130 entries more suited for analysis, e.g., by statistical techniques and/or machine learning.

In some embodiments, a conventional order is adopted, for instance, such that a lower value for a feature is associated with a lower risk than a higher value. Features can be engineered to ensure that the conventional order is obeyed, for instance by replacing values x with the result of a multiplication with a negative factor, e.g., −1x, or with a reciprocal value, e.g., x⁻¹, if they are naturally associated with an inverse order, i.e., an order in which a higher value is associated with a lower risk. As an example only, if an employee retention index is used as a KPI, it can be multiplied by −1, such that a lower value is associated with a lower risk.

In some embodiments, certain KPIs can be associated with a value or a range of values considered to be optimal. Features can be engineered to ensure that they reflect the optimal value(s), for instance by replacing values x with the absolute value of their distance to the optimal value or range o, e.g., |x−o|. As an example only, an optimal proportion of the manager's work time spent in meetings of 50% can be determined to be optimal in a given organization, the absolute value of the difference between the actual value and 50%, such that a value of 50% is associated with the lowest risk (0), and values of 0% or 100% are both associated with the highest risk (0.5).

It will be appreciated that additional feature engineering techniques may be applied, such as, for instance, handling outliers through removal or transformation, addressing missing data using imputation or interpolation, scaling features to normalize or standardize their ranges, and/or encoding categorical variables into numerical representations. In some embodiments, each indicator can be associated with different strategies, e.g., to address missing data. As an example only, missing values that are to be aggregated to create a feature can be left missing, whereas missing values that are to be used in a computation or directly used as a feature can have been imputed.

In some embodiments, different features including past data 120 can be associated with different history lengths. As an example only, certain features can be computed based on data from the last three months, whereas other features can be computed based on data from the last year. In some embodiments including features computed based on past data 120, strategies such as imputation or interpolation can be used to address missing past values related to employees that have been part of the organization and/or the team for less than the history length. In some embodiments, a portion of data 120 used to compute certain features can be omitted, for instance based on predetermined rules. As an example only, features computed based on information related to meetings can omit meetings with fewer or more than a certain number of participants, e.g., less than two or more than six, and/or shorter or longer than certain duration thresholds, e.g., less than 15 minutes or longer than eight hours, the numbers and thresholds being in some embodiments configurable distinctly for each feature.

In some embodiments, KPIs used to compute a global risk index to quantify a risk associated with a manager are grouped into categories or components related to specific aspects of the risk. Each category or component can have a category risk index computed based on an aggregation of the feature it encompasses, and the global risk index can be a result of aggregating the category risk indices of the different categories for a given manager. As examples only, in an exemplary embodiment, categories can include cultural alignment, inclusion and diversity, attraction, development, etc. In some embodiments, a hierarchy of categories or components is used, thereby creating subcategories or subcomponents, and/or supercategories or supercomponents. For instance, supercategories can be defined, each including a number of categories and having a supercategory risk index based on an aggregation of the corresponding category indices, the global risk index being computed as an aggregation of the supercategory indices. As examples only, in the exemplary embodiment, supercategories can include a cultural supercategory including at least the cultural alignment and inclusion and diversity categories, and an employee lifecycle supercategory including at least the attraction and development categories. In some embodiment, one data matrix 130 is created for each category or component of the lowest hierarchical level. As an example, in the exemplary embodiments having categories grouped into supercategories, one data matrix 130 can be created for each category and used to determine a category risk index.

The system includes a learning platform 140, which can for instance correspond to one or more computing devices. The learning platform 140 is configured to learn a model, e.g., a machine learning model based on each matrix 130. In some embodiments, the learning platform 140 implements a feature normalization module 142 to further prepare the feature values for learning and/or the model parameters for interpretation. In some embodiments, the learning platform 140 is provided with a matrix factorization module 144 configured to learn a non-negative matrix factorization (NMF) model 150, 160 from each matrix 130.

In some embodiments, the leaning platform 140 includes a feature normalization module 142 configured to further prepare the entries of each matrix 130 for model learning, and/or to prepare the parameters of the model, for instance the entries of the matrices 150, 160, for computation of risk indices and to ensure better interpretability. The normalization module 142 can be configured to apply further feature engineering steps related to normalization, including for instance scaling, standardization and/or distribution adjustment steps. In some embodiments, the normalization module 142 can implement standardization, e.g., based on Z-score, min-max scaling, max-absolute scaling, and/or robust scaling, e.g., relying on the median and interquartile range. In some embodiments, the normalization module 142 can implement distribution transformation operations to modify the distribution, for instance to make values more normally distributed and/or more stable, including for instance quantile-based transformations and/or power transformations such as the Yeo-Johnson transform or the Box-Cox transform. In some embodiments, a number of normalization operations can be performed in sequence. As an example only, before training the model, the values can first be scaled on a [1; 2] range, ensuring that no value is negative or close to zero, then be redistributed by applying the Box-Cox transform, then be rescaled on a [0; 1] range to ensure better interpretability while maintaining normality. As another example, once the model has been trained, the values can again be scaled on a [1; 2] range, ensuring that no value is close to zero, then be redistributed by applying the Box-Cox transform, then be rescaled on a [−1; 0] range and be multiplied by −1 to ensure better interpretability while maintaining normality. In some embodiments, the leaning platform 140 includes a matrix

factorization module 144 configured to learn a model based on the data matrix 130 by implementing non-negative matrix factorization. NMF can be used to factorize the nonnegative data matrix 130 into two lower-rank matrices, which correspond to the model: a coefficient matrix 150, which can be denoted as H, and a component matrix 160, which can be denoted as W. The data matrix 130, which can be denoted as V, is approximated as the product of these two matrices, such that V≈WH.

The matrix factorization module 144 is configured to initialize the matrices 150, 160 with suitable entries, then iteratively updating the matrices 150, 160 to minimize a reconstruction error between the original data matrix 130 and the product of the two matrices 150, 160, subject to the constraint that all elements in the matrices remain nonnegative. In some embodiments, matrices 150, 160 are initialized with random, nonnegative entries. In some embodiments, matrices 150, 160 are initialized based on a singular value decomposition of data matrix 130, which can result in faster convergence, ensuring either better results or faster computation. In some embodiments, zero values in the data matrix 130 are handled by initializing corresponding entries of matrices 150, 160 to small non-zero, non-negative values, which can lead to even faster convergence. The factorization is performed under the constraint that all values in the matrices 130, 150, 160 are nonnegative. The optimization can be performed until the reconstruction error is below a threshold, or for a configurable number of steps and/or duration, ensuring a predictable and fast computation time.

The coefficient matrix 150 represents the contribution of each component to the individual data points, whereas the component matrix 160 captures the underlying components or features that explain the observed data. Therefore, entries in the component matrix 160 can be used as an aggregation of the values of each row of the data matrix 130, which can be used as a risk index or can correspond to a representation of a risk index for each manager included in the data matrix 130 for the category associated with data matrix 130.

Compared to principal component analysis, which can require the computation of eigenvectors and eigenvalues through singular value decomposition (SVD), NMF can be more computationally efficient. This is particularly true in sparse datasets. NMF instead performs a simpler iterative optimization, which often results in faster processing times and lower memory usage. As an example, an embodiment of the disclosed NMF method demonstrated a statistically significant performance improvement of 0.04 seconds per benchmark test compared to a PCA implementation across 960 simulations involving approximately 1,800 managers, although the PCA implementation outperformed the NMF implementation in benchmarks conducted with 36,000 managers. Additionally, unlike PCA, which generates orthogonal components, NMF's parts-based, additive decomposition can lead to more interpretable features. Additionally, NMF offers an advantage over neural networks by providing a simpler, more efficient factorization without the need for complex training processes, resulting in faster processing times and lower memory usage.

In some embodiments, the matrix factorization module 144 is configured to decompose the data matrix 130 into a single component, i.e., when the data matrix 130 is a m×n matrix, into a coefficient matrix 150 of size 1×n, therefore corresponding to a row vector, and a component matrix 160 of size m×1, therefore corresponding to a column vector. This results in a highly interpretable representation that captures the dominant underlying pattern. This simplification also provides computational benefits, including faster processing times and reduced memory usage due to the lower dimensionality of the resulting matrices.

The system includes an index computation platform 170, which can for instance correspond to one or more computing devices, e.g., shared with or distinct from those of the learning platform 140. The index computation platform 170 is configured to compute risk indices, e.g., a numeric or discrete value of workplace risk associated with a manager overall of for a given category, subcategory or supercategory. The index computation platform 170 can implement an index computation module 172 configured to retrieve, process and/or aggregate risk-related entries from the component matrix 160, an index discretization module 174 configured to convert a numeric representation of a risk index in a discrete, e.g., categorical or ordinal, risk index, and/or a visualization module 176 configured to provide useful and intuitive visualizations allowing a user of system 100 to interpret the risk indices.

The index computation module 172 is configured to compute a risk index and/or a numerical representation of a risk index for a manager in each category, subcategory and/or supercategory defined in data matrices 130, based on entries of component matrix 160. The index computation module 172 is further configured to compute a global risk index and/or a numerical representation of a global risk index for a manager based on risk indices and/or numerical representations of risk indices in each category, subcategory and/or supercategory.

In some embodiments, for the lowest level of categories in the hierarchy of categories, each corresponding to one component matrix 160, the relevant entries for a manager in each component matrix 160 represents the risk index of the manager for the category or subcategory associated with the component matrix 160. The numerical representation of the risk index extracted from each component matrix 160 can be used as is and/or can be discretized by the index discretization module. In some embodiments, each intermediary level of categories from the hierarchy of categories is associated with a risk index aggregated based on numerical representations of the respective risk indices of the respective subcategories of the respective category and/or on the respective discretized risk indices of the respective subcategories. The aggregation can for instance correspond to a statistical measure such as a boundary value, for instance a maximum, a minimum, a quantile value, or a central measure, for instance a weighted or unweighted mean, e.g., an arithmetic mean, a geometric mean, or a harmonic mean, a median or a mode, based on the numerical or categorical values associated with the lower-level categories subsumed by the higher-level category. In some embodiments, the global risk index associated with a manager is computed from an aggregation based on numerical representations of the respective risk indices of the top-level categories and/or on the respective discretized risk indices of the top-level categories.

It can be appreciated that the system 100 can be used to define any suitable depth of category hierarchy, such that for instance some embodiments can use only one level of categories, i.e., each lowest-level category is also a top-level category, some embodiments can use two levels of categories, i.e., each lowest-level category is subsumed by exactly one category which is a top-level category, and some embodiments can use a higher number of levels of categories, i.e., defining lowest-level categories, intermediary categories and top-level categories. In some embodiments, at aggregation time, categorical risk indices are converted to ordinal indices allowing for the calculation of, e.g., a mode. In some embodiments, at aggregation time, categorical or ordinal risk indices are converted to numerical indices allowing for the calculation of, e.g., a mean or a median.

In some embodiments, the index computation platform implements an index discretization module 174 configured to convert a numerical representation of a risk index computed by the index computation module 172 in a discrete, e.g., ordinal or categorical risk index. In other words, the index discretization modules can define a configurable number n of categories and/or ranks. In some embodiments, given a plurality of managers each associated with a risk index, a substantially equal number of managers can be placed in each category and/or rank. In some embodiments, given n categories and/or ranks, each risk index can be placed in one of the categories and/or ranks based on comparing a numerical representation of the risk index with n−1 thresholds. In some embodiments, each category and/or rank can be associated or labelled with a colour. As an example only, N=4 categories or rank can be respectively labelled with “green”, “yellow”, “orange” and “red”, e.g., with “green” indicating the most desirable risk index, “red” indicating the least desirable risk index, and intermediary labels representing intermediary levels of desirability.

In some embodiments, the thresholds are defined based on statistical measures applied to the distribution of the risk indices and/or of the numerical representations of the risk indices. In some embodiments, the thresholds can be defined based on quantile values. As an example only, n=4 categories or rank can be defined respectively by the 40^{th}, the 50^{th} and the 95^{th} percentile values. As another example, n=4 categories or rank can be defined respectively by the 400^{th}, the 675^{th} and the 950^{th} milile values. As examples only, combining examples above, the 40% lowest risk indices can be categorized as “green”, the 10-27.5% next lowest risk indices can be categorized as “yellow”, the subsequent 27.5-45% lowest risk indices can be categorized as “orange”, and the highest 5% risk indices can be categorized as “red”.

In some embodiments, the managers can be divided into suitable groups of managers and each group of managers can have their risk index discretized independently from values in the other groups. As an example only, managers of teams including employees in customer-facing roles can be grouped distinctly from managers of teams including employees working in corporate roles, to reflect the distinction of the challenges met by the employees, teams and managers. As another example, managers can be grouped based on their span of control and/or on the size of the teams they directly and/or indirectly manage.

In some embodiments, a classification and/or a regression model is trained to divide managers into suitable groups based on features such as one or more employee-based role groupings, the number of employees they directly manage, and/or the number of employees they indirectly manage. In some embodiments, for different categories, subcategories and/or supercategories, managers can be placed in different groups. In some embodiments, the category, subcategory or supercategory for which a risk index is to be discretized is provided as a feature to the model. In some embodiments, a different model can be trained for each category, subcategory or supercategory. As an example, a decision tree can be trained, and the leaves of the model can be used to define the groups. A suitable number of groups can be configured, or a minimum and/or a maximum number of groups can be configured.

In some embodiments, a classification and/or a regression model is trained to convert a numerical representation of a risk index computed by the index computation module 172 in a discrete, e.g., ordinal or categorical risk index. In some embodiments, different thresholds can be defined based on factors such as a manager's span of control and/or on the size of the teams they directly and/or indirectly manage. In some embodiments, thresholds can be defined based on curves fitted to a suitable plot, for instance a plot displaying the relationship between team size (x-axis) and the manager's risk index (y-axis). In some embodiments, two curves corresponding to the first threshold and to the last threshold are fitted as part of solving one optimization problem. A suitable linear function can be selected for each curve, e.g., y=ax+k, where y is the threshold with respect to factor x, e.g., team size, and curve a and intercept k are the parameters learned for each curve, for instance through optimization using a suitable objective function. For instance, the objective function can apply penalties when points of the curves drifts away from a configurable quantile, e.g., 5% for the lowest threshold and 60% for the highest threshold, when the two curves move closer to one another, and/or when the two curves intersect. As examples only, a penalty for a curve drifting away from the configured quantile can be computed based on the length of the curve that is above the quantile, a penalty to keep the two curves sufficiently apart can be computed as −|y_{↓}⁺−y_{↑}⁻|/10 where yᵢ⁺ is the maximum of the lowest threshold curve and y_{↑}⁻ is the minimum of the highest threshold curve, and a penalty to avoid intersections can be set to a high value such as 1,000 if the curves intersect one another. In some embodiments,

differential evolution is used, by adjusting candidate parameters of the model over multiple generations to minimize the objective function. In some embodiments, all the thresholds are optimized at once. In some embodiments, thresholds are optimized pairwise, e.g., the lowest with the highest, the second lowest with the second highest, etc. In some embodiments, the lowest threshold is optimized with the highest threshold and the intermediary threshold(s) curve(s) are computed based on the distance between the lowest and the highest threshold curves. As an example, intermediary threshold(s) curve(s) can be fitted such that all threshold curves are at substantially equal distances of the lower and higher curves. As a more specific example, when three thresholds are fitted to define four categories and/or ranks, the intermediary threshold curve can be fitted to be equidistant from the highest and lowest threshold curves at all points. In some embodiments, more than one model is trained to compute thresholds. As an example, one model can be trained for each category, subcategory or supercategory, and/or for each group of managers.

In some embodiments, the index computation module 172 and the index discretization module 174 are configured to perform risk indices aggregation by encoding the indices into numerical representations, processing the numerical representations to obtain an aggregated numerical representation, and discretizing the numerical representation. For instance, if the risk indices exist on a n-point ordinal scale and/or a n-category classification, the lowest risk index can be encoded as 1, the highest-risk index can be encoded as N, and the intermediary indices can be encoded with integer values greater than 1 and less than N that increase as the risk level rises. As an example only, with four ranks and/or categories labelled with colours “green”, “yellow”, “orange” and “red”, “green” can be encoded as 1, “yellow” as 2, “orange” as 3 and “red” as 4. The numerical representations can then be aggregated as described above, for instance using an arithmetic mean. Finally, the aggregated numerical representation can be discretized again, for instance using custom binning, i.e., based on predetermined thresholds. To continue the example above, values in range [1; 1.75] can be assigned the “green” label, [1.75; 2.5] the “yellow” label, [2.5; 3.25] the “orange” label, and [3.25; 4] the “red” label.

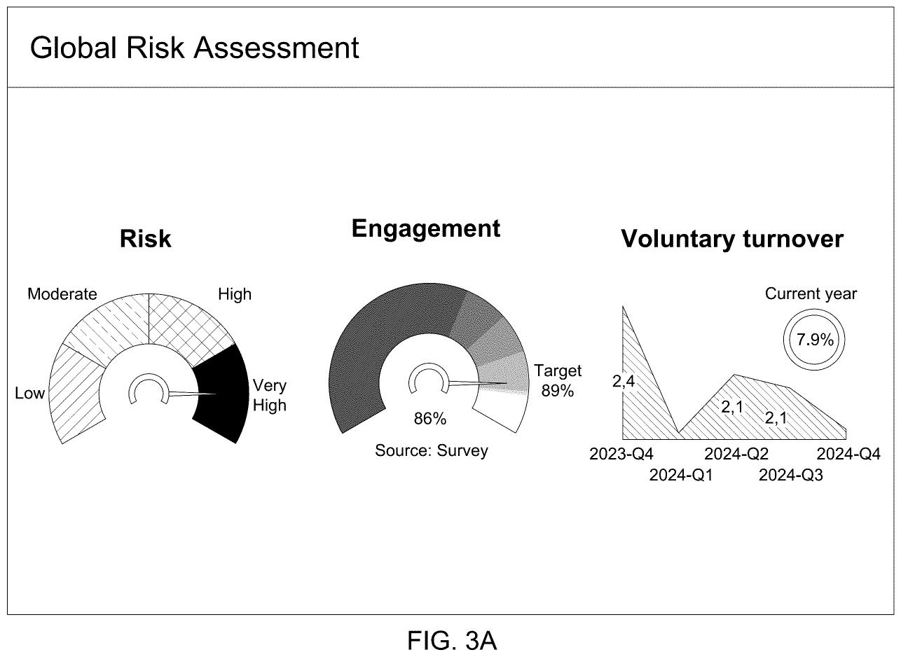

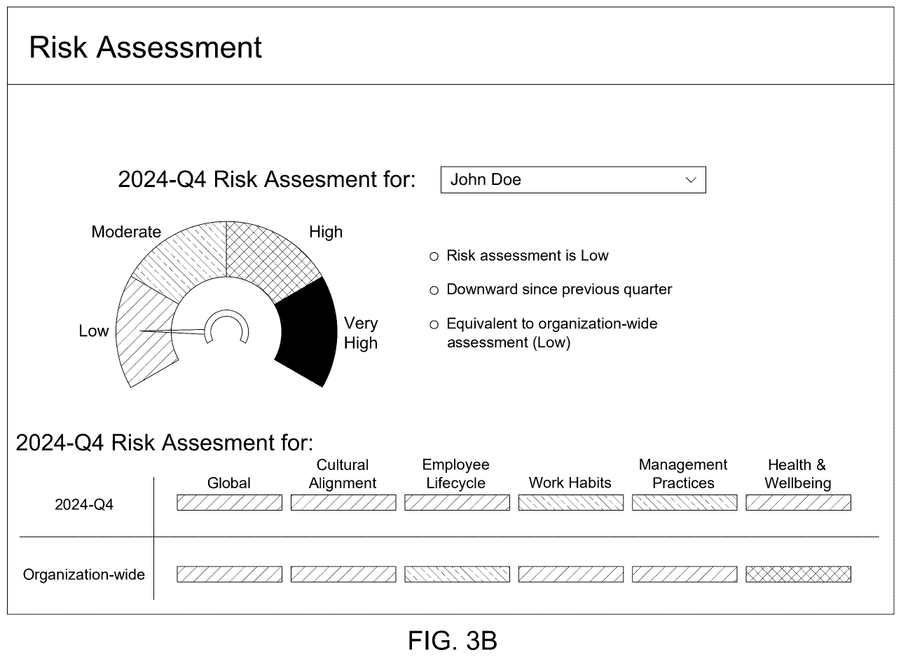

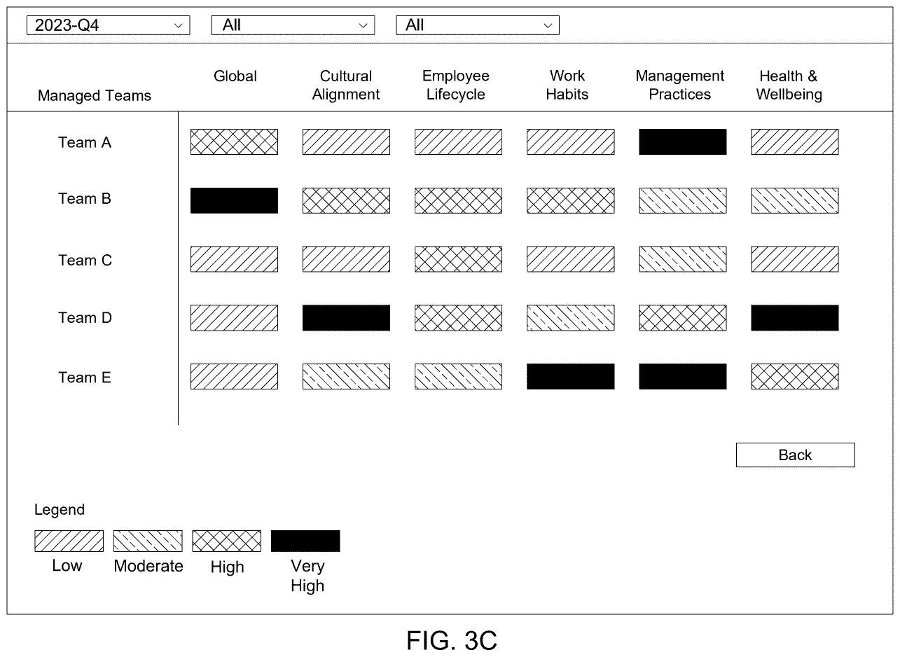

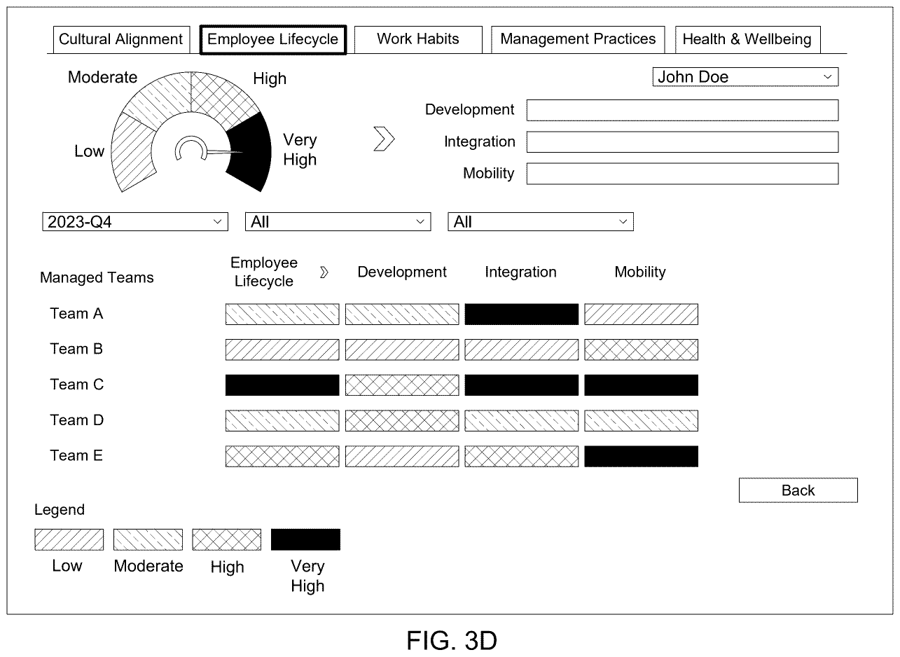

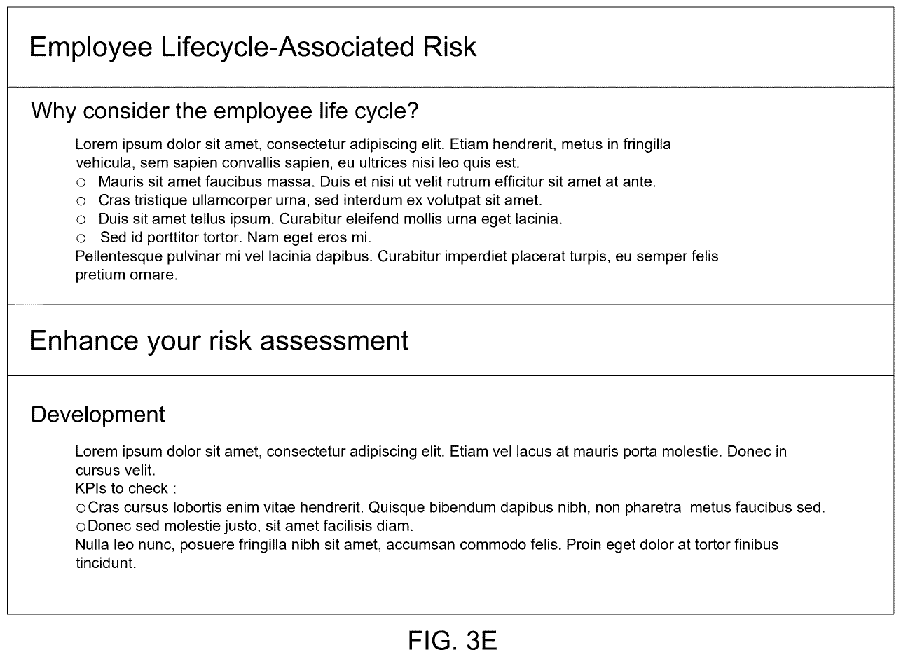

In some embodiments, the index computation platform implements a visualization module 176 configured to provide helpful and intuitive visualizations of risk indices to a user of system 100 through a consultation device 180. The visualization module 176 can be configured to generate a graphical user interface to allow the user to view and interpret the risk indices described herein, as shown below with respect to FIGS. 3A to 3E. As can be appreciated, the visualization module 176 can be configured to generate the GUI in the form of a web page consisting of code in one or more computer languages, such as HTML, XML, CSS, JavaScript™ and ECMAScript™. In some embodiments, the GUI can be generated programmatically, for instance on a server hosting the visualization module 176, and rendered by an application such as a web browser on a consultation device 180, such as a workstation. In other embodiments, the consultation device 180 can be configured to generate the GUI via a native application running on the user device, for example, comprising graphical widgets configured to render information received from the visualization module 176. Additionally, the GUI can be provided by visual analytics platform such as Power BI™, Google™ Looker™ Studio, Tableau™, or IBM™ Cognos™ Analytics, which can offer capabilities for visualizing and interacting with data and allow for the creation of dynamic and customizable dashboards and reports.

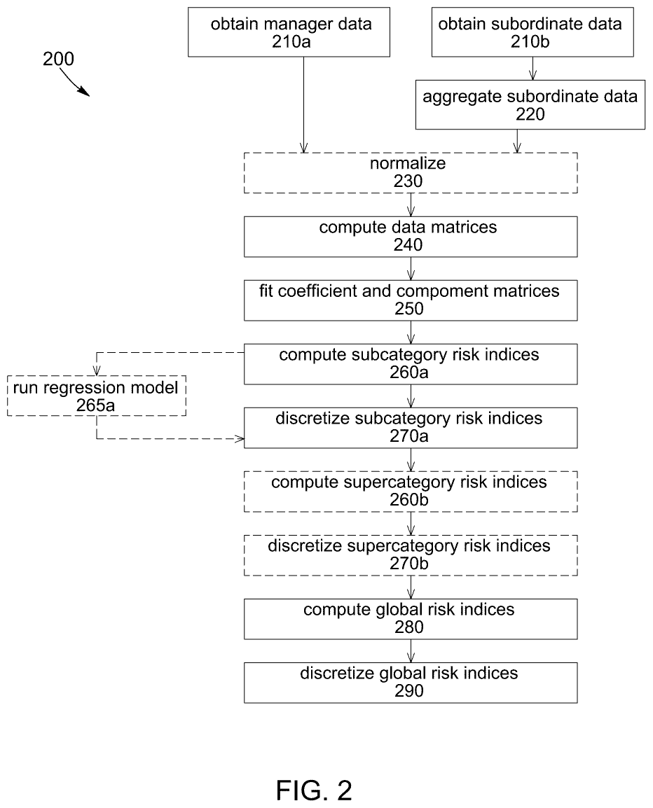

With reference to FIG. 2, an exemplary method 200 for quantifying a risk associated with managers of an organization is shown. Broadly described, data is obtained 210a, b, aggregated if needed 220, and put in matrix form 240 to apply matrix factorization 250. Risk indices are computed 260a, b, discretized 270a, b, and used to compute global risk indices 280. In some embodiments, method 200 is implemented by system 100.

The method 200 includes initial steps 210a, b of obtaining workplace data related to a manager, including obtaining workplace data associated with the manager themselves in step 210a and/or obtaining workplace data associated with subordinates of the manager in step 210b. Steps 210a and 210b can be performed continuously, from time to time, based on the different refresh rates of different sources of data. As an example, fresh survey-based data could be obtained every three or six months, whereas fresh attendance-based data could be obtained every day or week. Steps 210a, b can include cross-referencing different data, possibly from different sources, to compute relevant indicators.

The method 200 includes a step 220, subsequent to step 210b being performed to obtain fresh subordinate data, of aggregating the subordinate data, for instance using statistical measures, to obtain a single indicator applicable to the manager of the subordinates.

The method 200 can include a step 230 of normalizing the workplace data, aggregated workplace data and/or indicators obtained and/or computed in steps 210a, b, 220. Normalizing the data can include steps to scale the data, to redistribute the data for instance to create a substantially normal distribution for a given indicator, to enforce a specific meaning to the order between data points, e.g., to ensure that higher values are associated with a higher risk, to handle missing values, e.g., by imputation, and to ensure that all the indicators are nonnegative.

The method 200 includes a step 240 of tabulating indicators into data matrices. Key performance indicators can be selected from the data obtained and/or computed in steps 210a, b, 220 and optionally normalized in step 230, and made into tabular format. Each line of the tabular data can correspond to one manager, and each column can correspond to a KPI. The tabular data can be provided as a matrix, for instance a n×m data matrix V representing m KPIs for n managers, in which cell Vᵢⱼ represents the value of the j^{th} KPI for the i^{th} manager. KPIs can be grouped in categories, and one data matrix can be provided for each category.

The method 200 includes a step 250 of fitting a coefficient matrix H and a component matrix W such that HW approximates V for each data matrix V. Matrices H and W can for instance be fitted using nonnegative matrix factorization, provided that all entries of V are nonnegative, generating matrices H and W that too only include nonnegative entries. In some embodiments, each matrix H and each matrix W fitted on a data matrix V of size n×m respectively have a size of 1×m and n×1, i.e., matrices H and W are respectively row vectors and column vectors.

The method 200 can include steps 260a, b, 270a, b to compute and discretize risk indices for categories. Categories can include one or multiple levels of a category hierarchy. In some embodiments, the category hierarchy includes two levels, and the categories therefore include a set of subcategories and a set of supercategories, each subcategory being included in exactly one supercategory, and each supercategory including one or more subcategories. The exemplary embodiment illustrated in FIG. 2 includes two levels of categories, although it can be appreciated that the second level is optional and therefore that steps 260b and 270b are too optional. In some embodiments, more than two levels of categories are included and therefore steps 260b and 270b are repeated for each category level higher than the lowest category level.

The method 200 includes a step 260a of computing a risk index for each manager and for each category of the lowest level of the hierarchy, e.g., for each subcategory. The risk indices computed at step 260a can be a numerical representation of the risk indices. The risk indices can be extracted from component matrix W. In particular, if W is a column vector, the numerical representation of the risk index for the i^{th} manager for the associated subcategory can be taken from Wᵢ.

The method 200 can include a step 270a of discretizing the risk indices computed in step 260a if they are numerical. Risk indices can for instance be discretized so as to exist on a n-point ordinal scale, e.g., a 4-point ordinal scale where each rank is associated with a colour corresponding to an indication of one of four ordered categories risk levels. Discretizing a numerical risk index on a n-point ordinal scale can include comparing the numerical value of the risk index to n−1 thresholds. The thresholds can be computed based on configurable quantile values, e.g., based on the 40^{th}, 50^{th} and 95^{th} percentiles, or based on the 400^{th}, 675^{th} and 950^{th} mililes.

In some embodiments, the method 200 includes a step 265 of computing thresholds by running a regression model. This step can be leveraged to advantageously reflect the fact that risk indices have different distributions based on different factors, for instance based on the category, based on the type of team associated with the manager, and/or based on the span of control of the manager. The regression model can be a linear regression model defining at least two curves each associated with one of at least two thresholds. The parameters of the model can be fitted by optimizing an objective function that penalizes certain undesirable characteristics of the threshold curves and/or incentivizes certain desirable characteristics of the threshold curves. When more than two thresholds are used, more than two curves can be fitted, and/or certain curves can be defined based on other curves. As an example, with three thresholds, the highest and the lowest thresholds can be fitted using an objective function, and the intermediary threshold can be defined as the curve equidistant in all points to the highest and the lowest threshold curves. Once step 265 has determined the thresholds, step 270a can discretize the indices.

In embodiments including more than one level of categories, the method 200 includes a subsequent step 260b of computing the supercategory risk indices. A supercategory risk index can be computed based on corresponding subcategory risk indices of the subcategories included in the supercategory, e.g., by aggregating them. As an example, subcategory risk indices can be encoded to numerical values, for instance 1, 2, . . . , n, where n is the number of possible ordinal values, then be aggregated for instance using a central measure such as the mean.

If the resulting supercategory risk indices correspond to a numerical representation, for instance if they correspond to the mean of a numerical encoding of the subcategory indices, the method 200 provides a step 270b of discretizing them once again. Although approaches similar to these used in step 270a can be implemented, because the distribution of the encoded indices is more constrained than the distribution of the components from W, a simpler approach can advantageously be implemented. As an example, if 1, 2, . . . , n values was used, the mean computed in step 260b will be bound by [1; n], and it can be straightforward to determine fixed thresholds to use in binning the risk indices back to n possible ordinal values.

Once all category risk indices up to the highest-level of supercategories have been computed, a global risk index can be computed for each manager in step 280. The global risk index can correspond to an aggregation of the global risk indices for the highest-level supercategories, for instance the supercategory risk indices computed and/or discretized in steps 260b, 270b. The aggregation of the global risk indices can for instance be performed in the same way as the aggregation of supercategory risk indices based on subcategory risk indices in step 260b. If necessary, the method 200 can include a final step of discretizing the global risk indices, which also can implement similar approaches as that of step 270b.

With reference to FIGS. 3A to 3E, different views of an exemplary graphical user interface are illustrated.

FIG. 3A if an exemplary view allowing a manager to visualize their personal global risk index, along with a selection of current or historical KPI values that are particularly relevant. The view allows the manager to consult more detailed reports regarding the global risk assessment of the particular KPIs.

FIG. 3B is an exemplary view allowing a user to visualize the global personal risk index at the level of a manager, along with the risk indices associated with each of the top-level categories. The view also allows the user to visualize the evolution of the manager's global risk index and to visualize how well the manager is doing compared with the rest of the organization.

FIG. 3C is an exemplary view allowing a user to visualize the risk indices associated with each of the top-level categories associated with each of the managers that fall within their span of control. The view allows the user a better understanding of their own risk indices and enables inspection and intervention with respect to their subordinate managers.

FIG. 3D is an exemplary view allowing a user to visualize and explore individual KPIs that factor in the risk indices at the level of a manager.

FIG. 3E is an exemplary view allowing a user to gain insight related to the risk index associated with a given category. The view also presents KPIs that are particularly relevant with respect to the category.

One or more systems, methods, modules, steps or functionalities described herein may be implemented in computer programs executed on one or more processing devices, each comprising at least one processor, a data storage system (including both volatile and/or non-volatile memory and/or storage elements), and optionally at least one input and/or output device. These processing devices encompass a broad range of electronic systems capable of receiving, processing, and/or transmitting data. Examples of processing devices include, without limitation, general-purpose computers, specialized computing devices, and embedded systems. Processing devices may be implemented on dedicated hardware, including programmable hardware such as field-programmable gate arrays (FPGAs), or as software-based solutions on cloud computing platforms or serverless architectures.

Processing devices suitable for implementing the present invention may include programmable logic units, mainframe computers, servers, personal computers, laptops, cloud-based systems, personal digital assistants (PDAs), cellular telephones, smartphones, wearable devices, tablets, video game consoles, and portable video game devices. Each of these devices has the ability to execute instructions and can operate individually or in combination to perform the functionality described. The processing devices may be deployed in a variety of configurations, from single-device implementations to distributed systems that involve multiple devices collaborating to achieve a common purpose. For example, a method could be implemented on a single microcontroller in an embedded system, or distributed across a network of servers that share computational tasks.

The instructions that enable a processing device to perform a given method or function can be stored in the form of a computer program. This computer program may be implemented in a high-level programming language, such as an imperative language, including procedural or object-oriented languages like C++, Java, or Python, which are suited for a wide range of applications and can easily interface with various system components. High-level programming languages can also include declarative languages, such as functional languages like Haskell or logic languages like Prolog, which allow developers to specify what the program should accomplish rather than describing step-by-step operations. These high-level languages can improve development efficiency and code readability.

Alternatively, computer programs may be implemented in low-level languages, such as assembly or machine code, especially when direct hardware control or optimization is required. Low-level languages are closer to machine instructions and provide precise control over hardware resources, which can be advantageous in resource-constrained environments, such as embedded systems. Programs written in low-level languages can be used in applications that require high performance, small memory footprints, or real-time processing capabilities.

Each computer program may be either compiled or interpreted. Compiled languages, such as C or C++, can be transformed into machine code optimized for a specific hardware configuration, allowing efficient execution. Compilation can result in highly optimized executables that are tailored to the underlying architecture, which is advantageous in performance-critical applications. Interpreted languages, such as Python or JavaScript, offer flexibility by interpreting code at runtime. This allows for rapid development and platform independence, as the same code can be run on different systems with minimal modifications. Hybrid approaches, such as Java bytecode or . NET Common Intermediate Language (CIL), combine elements of both compiled and interpreted paradigms. In these cases, code is compiled to an intermediate representation that can be executed by a virtual machine on various platforms, providing cross-platform compatibility.

Each computer program implementing the methods or systems described herein is preferably stored on a computer-readable storage medium or device. Examples of such storage media include hard drives, solid-state drives, optical disks, flash memory, and magnetic tape. The computer-readable storage medium is readable by a general or special-purpose programmable computer, which, upon reading the instructions, can configure itself to perform the steps described herein. These instructions may include executable code, scripts, or markup that instructs the computer on how to operate and handle data, making the system or method functional. In some embodiments, the system or method may be embedded within an operating system running on a programmable computer, allowing for deeper integration with the hardware and enabling enhanced performance, security, or user interface features.

Processing devices implementing the present invention may contain a variety of hardware components that support program execution. Processors used within these devices include general-purpose central processing units (CPUs), which are capable of executing a wide variety of instructions, as well as specialized processors. Examples of specialized processors include graphics processing units (GPUs), which can be optimized for parallel processing and/or used in data-intensive applications like machine learning, digital signal processors (DSPs), which are designed for handling real-time audio, video, and other signal processing tasks, and application-specific integrated circuits (ASICs), which are tailored to specific functions and are often used in applications requiring high efficiency. Multi-core and/or multithreaded processors can allow for concurrent execution of multiple tasks, improving overall performance, for instance in multi-user or real-time environments.

The processing device may further include various types of memory. Volatile memory, such as registers, cache, and random-access memory (RAM), can be used for temporary data storage during active program execution, providing fast access to data that the processor frequently uses. Non-volatile memory, such as read-only memory (ROM), flash memory, solid-state drives, hard disks, and optical disks, can be used to retain data even when the processing device is powered off, making it suitable for long-term data storage. Other examples of non-volatile storage media include diskettes, magnetic tapes, chips, and compact disks, among others. The type of memory selected can depend on specific requirements, such as the need for rapid access, data retention, or data durability under power cycling. The memory configuration of a processing device can be adjusted to support varying levels of computational demand, from lightweight applications with minimal memory requirements to complex systems requiring large data caches.

Networking solutions within a processing device enable inter-process communication and network communication over wired or wireless connections. Examples of networking technologies include Ethernet for high-speed wired connections, Wi-Fi for wireless data transmission, Bluetooth™ for short-range device communication, and cellular networks for broader geographic coverage. These networking solutions support various network topologies, including local area networks (LAN), wide area networks (WAN), and other network types such as personal area networks (PAN) and metropolitan area networks (MAN), as well as the Internet. Through these networks, processing devices can communicate with one another to distribute tasks, share data, and collaborate on complex computations. This communication can occur within a single building or across geographically dispersed locations, depending on the application requirements.

Implementing networking security measures can be advantageous to protect data as it travels across potentially vulnerable channels. Key security principles can include confidentiality, integrity, and availability. Confidentiality can be achieved for instance through encryption protocols like Secure Sockets Layer (SSL) and Transport Layer Security (TLS), ensuring that data remains private. Integrity can be maintained for instance with cryptographic hashing and/or digital signatures, which can detect tampering, while availability can be protected for instance by redundancy, load balancing, and defences against denial-of-service (DoS) attacks. Access control mechanisms, including multifactor authentication and role-based access control, can be used to regulate network access. Network segmentation, such as virtual LANs (VLANs) and demilitarized zones (DMZs), can be implemented to limit access to sensitive areas and reduces the impact of breaches, while firewalls filter traffic based on predefined rules, providing an essential barrier between internal and external networks.

Advanced security measures for networking can be implemented, for instance, including encryption for wireless networks through protocols like Wi-Fi Protected Access 3 (WPA3 ), which can prevent unauthorized access to Wi-Fi. Intrusion detection and prevention systems (IDS/IPS) can be used to monitor network traffic for malicious activity, while virtual private networks (VPNs) can be used to establish secure connections for remote access over public networks. Regular security assessments, such as penetration testing and vulnerability scanning, identify weaknesses, and security information and event management (SIEM) systems may be leveraged to provide real-time insights into potential threats. A layered security approach, or defence in depth, can combine multiple controls across different levels of the network, enhancing resilience against both internal and external attacks by creating multiple barriers that attackers must overcome.

Distributed computing is a possible implementation in which multiple processing devices work together to perform tasks described herein. For example, a method or a method step may execute within a single thread on one processing device or be distributed across multiple threads, cores, or processors on a single device or across multiple devices. Distributed computing can help implement parallelization, where tasks are split into smaller subtasks that are processed concurrently, significantly improving processing speed and efficiency. This approach is well suited to applications with high computational demands, such as data analysis, machine learning, and large-scale simulations. In some implementations, processors are located within a single physical location, while in others, they may be spread across multiple sites, allowing for redundant and resilient computing infrastructures.

Distributed computing can also be implemented within a cloud computing environment, offering flexibility and scalability. Cloud computing architectures enable the allocation of computational resources on demand, allowing tasks to utilize as many or as few resources as needed for efficient execution. For instance, a single computational process may span multiple virtual machines, distributed across data centres in different geographical locations, to achieve optimal performance and fault tolerance. By leveraging multi-tenant architectures and dynamic scaling, cloud platforms allocate resources only as needed, reducing idle computational power. Furthermore, this approach facilitates cost efficiency, as users pay only for the resources they consume. Additionally, cloud computing's ability to pool resources across large-scale infrastructure provides inherent redundancy and resilience, ensuring high availability for critical applications. Cloud computing can include employing containers and microservices to enhance resource efficiency and streamline deployment. Containers encapsulate applications and their dependencies in lightweight, portable units that can run consistently across different environments. This allows distributed computing tasks to be executed reliably across heterogeneous systems, reducing compatibility issues. Microservices architectures further divide applications into smaller, independently deployable services, each responsible for a specific functionality. These services can scale independently, ensuring that resources are allocated precisely where needed and minimizing waste. Together, containers and microservices enable more efficient use of computational resources, shorter deployment cycles, and improved fault isolation.

The systems and methods described herein can be distributed using edge computing architectures. Edge computing can introduce additional layers to distributed and cloud computing by bringing certain processing capabilities closer to data sources, such as sensors or devices in the industrial Internet of Things (IIoT). In this architecture, certain computational tasks can be offloaded to edge devices, such as gateways or local servers, reducing latency and minimizing the volume of data transmitted to centralized data centres. This approach can be particularly advantageous in IIoT applications where real-time decision-making can be critical, such as predictive maintenance, autonomous control systems, or industrial automation. By processing data locally, edge computing can reduce bandwidth requirements, enhance data privacy, and ensure continuity of operations even when connectivity to the cloud is intermittent. This integration of edge and cloud computing can allow organizations to benefit from both localized processing and the scalability of centralized resources.

The systems and methods described herein may also be distributed in one or more computer program products, each including a computer-readable medium that bears computer-usable instructions for one or more processors. These instructions can exist in various forms, including compiled and non-compiled code, providing the flexibility needed for deployment in diverse computing environments. For example, compiled binaries may be optimized for specific hardware, while interpreted scripts or markup files can be deployed in environments where cross-platform compatibility or rapid updates are needed.

The storage and retrieval of data in a computer system may involve various data storage solutions, including relational databases, which store data in structured tables with defined relationships, and NoSQL™ databases, which offer more flexible storage schemas suited to unstructured or semi-structured data. In-memory databases, which store data entirely in RAM for rapid access, can also be used in applications where low latency is desirable. These data storage solutions may be implemented on local servers, within distributed storage systems, or as part of cloud-based infrastructures, offering scalability and accessibility as required by the application. Distributed storage solutions can enable high availability and fault tolerance, ensuring that data remains accessible even if one part of the storage infrastructure fails.

Input and output devices connected to the processing device can facilitate interaction with users and other systems. Input devices can include standard peripherals, such as keyboards, mice, touchscreens, and microphones, as well as specialized input devices, such as biometric scanners, cameras, and sensors for capturing environmental data. Output devices may encompass monitors, printers, speakers, projectors, and other display systems that present information to users in various formats. These input and output devices enable users to interact with the system in intuitive ways, supporting diverse functionalities from user control of applications to data visualization and multimedia output.

The systems and methods described herein are thus capable of deployment across a broad spectrum of computing environments, supporting applications from simple embedded systems to large-scale distributed computing networks. Each component and approach described herein contributes to the versatility and adaptability of the invention, making it suitable for a wide variety of practical implementations across industries and use cases.

In this disclosure, unless the context explicitly requires otherwise, the term “comprise” and its variations, such as “comprises” and “comprising,” are intended to be interpreted in an inclusive manner. This means that the presence of specified features or elements does not exclude the possibility of additional features, elements, or steps being included in various embodiments.

Any reference to prior art publications within this disclosure should not be taken as an acknowledgment or admission that these publications form part of the common general knowledge in the relevant field, whether in any particular jurisdiction or globally.

The examples provided in the above description serve to illustrate specific embodiments and convey certain features and principles. However, those skilled in the art will recognize that individual features, elements, and functionalities within the disclosed embodiments may be adapted, modified, or combined in numerous ways without departing from the core spirit or intended scope of the described subject matter. Therefore, the foregoing description is meant to be illustrative rather than limiting, with the scope being defined by the appended claims, which are intended to encompass all variations and modifications within the broadest interpretation permitted by applicable law.

1. A computer-implemented method for providing measurable workplace risk assessments associated with a plurality of managers, the method comprising:
obtaining a plurality of values, each value associated with one feature from a plurality of workplace behaviour or assessment features and with one manager, wherein each feature is associated with one category from a plurality of risk assessment categories;
computing a respective data matrix of a plurality of data matrices for each subset of features of the workplace behaviour or assessment features associated with each given category, the respective data matrix comprising a plurality of rows each corresponding to one manager and a plurality of columns each corresponding to one feature from the subset of features;
fitting a respective machine learning model of a plurality of machine learning models onto the data matrix for each data matrix associated with a respective category, the respective machine learning model comprising a respective coefficient matrix from a plurality of coefficient matrices and a respective component matrix from a plurality of component matrices, wherein:
each coefficient matrix is a nonnegative row vector,
each component matrix is a nonnegative column vector,
each machine learning model is fitted using non-negative matrix factorization, and
each row of each component matrix is associated with a row of the data matrix corresponding to a respective manager and represents a risk index of the respective manager with respect to the respective category;
computing a plurality of category risk indices associated with each respective category and each manager, wherein each category risk index exists on an n-point ordinal scale, and wherein each category risk index is computed based on a respective component matrix value associated with a respective category and a respective manager, and n−1 thresholds; and
computing a global risk index associated with each manager based on a central value of the category risk indices, wherein the global risk index quantifies the risk associated with the manager.

2. The method of claim 1, wherein the categories comprise subcategories and supercategories, each subcategory being comprised in a supercategory, each supercategory having a supercategory risk index of a plurality of supercategory risk indices based on an aggregation of the category risk indices, and wherein the global risk index is based on an aggregation of the supercategory risk indices.

3. The method of claim 2, wherein the supercategory risk index of each supercategory is based on a central value of the category risk indices, and wherein the global risk index is based on a central value of the supercategory risk indices.

4. The method of claim 1, wherein each of the thresholds is computed based on a quantile of values in the respective nonnegative column vector.

5. The method of claim 4, wherein n is 4 and the thresholds are computed based on a 40th, a 50th and a 95th percentile of the values in the respective nonnegative column vector.

6. The method of claim 4, wherein n is 4 and the thresholds are computed based on a 400th, a 675th and a 950th milile of the values in the respective nonnegative column vector.

7. The method of claim 4, each of the thresholds is optimized by a linear regression model based on a span of control of each manager.

8. The method of claim 7, wherein parameters of the linear regression model are determined based on a solution of an optimization problem.

9. The method of claim 1, wherein each point of the n-point ordinal scale is associated with a numeric value, and wherein the global risk index is computed based on a mean of numeric values associated with the category risk indices.

10. The method of claim 1, wherein the global risk index exists on the n-point ordinal scale, wherein each point of the n-point ordinal scale is associated with a numeric value, and wherein the global risk index is computed based on a discretized mean of numeric values associated with the category risk indices.

11. A system for providing measurable workplace risk assessments associated with a plurality of managers, the system comprising:
at least one data sources configured to obtain a plurality of values, each value associated with one feature from a plurality of workplace behaviour or assessment features and with one manager, wherein each feature is associated with one category from a plurality of risk assessment categories;
a learning computer-implemented platform configured to:
compute a respective data matrix of a plurality of data matrices for each subset of features of the workplace behaviour or assessment features associated with each given category, the respective data matrix comprising a plurality of rows each corresponding to one manager and a plurality of columns each corresponding to one feature from the subset of features,
fit a respective machine learning model of a plurality of machine learning models onto the data matrix for each data matrix associated with a respective category, the respective machine learning model comprising a respective coefficient matrix from a plurality of coefficient matrices and a respective component matrix from a plurality of component matrices, wherein:
each coefficient matrix is a nonnegative row vector,
each component matrix is a nonnegative column vector,
each machine learning model is fitted using non-negative matrix factorization, and
each row of each component matrix is associated with a row of the data matrix corresponding to a respective manager and represents a risk index of the respective manager with respect to the respective category;
a computer-implemented index computation platform configured to:
compute a plurality of category risk indices associated with each respective category and each manager, wherein each category risk index exists on an n-point ordinal scale, and wherein each category risk index is computed based on a respective component matrix value associated with a respective category and a respective manager, and n−1 thresholds,
computing a global risk index associated with each manager based on a central value of the category risk indices, wherein the global risk index quantifies the risk associated with the manager, and
implement a visualization module configured to provide visualizations of the global risk index and the category risk indices; and
a consultation device configured to display the visualizations.

12. The system of claim 11, wherein the categories comprise subcategories and supercategories, each subcategory being comprised in a supercategory, each supercategory having a supercategory risk index of a plurality of supercategory risk indices based on an aggregation of the category risk indices, and wherein the global risk index is based on an aggregation of the supercategory risk indices.

13. The system of claim 11, wherein each of the thresholds is computed based on a quantile of values in the respective nonnegative column vector.

14. The system of claim 13, wherein n is 4 and the thresholds are computed based on a 40th, a 50th and a 95th percentile of the values in the respective nonnegative column vector.

15. The system of claim 13, wherein n is 4 and the thresholds are computed based on a 400th, a 675th and a 950th milile of the values in the respective nonnegative column vector.

16. The system of claim 13, each of the thresholds is optimized by a linear regression model based on a span of control of each manager.

17. The system of claim 16, wherein parameters of the linear regression model are determined based on a solution of an optimization problem.

18. The system of claim 11, wherein each point of the n-point ordinal scale is associated with a numeric value, and wherein the global risk index is computed based on a mean of numeric values associated with the category risk indices.

19. The system of claim 11, wherein the global risk index exists on the n-point ordinal scale, wherein each point of the n-point ordinal scale is associated with a numeric value, and wherein the global risk index is computed based on a discretized mean of numeric values associated with the category risk indices.

20. At least one non-transient computer readable memory storing computer executable instructions thereon that when executed by at least one processor causes the at least one processor to:
obtain a plurality of values, each value associated with one feature from a plurality of workplace behaviour or assessment features and with one manager, wherein each feature is associated with one category from a plurality of risk assessment categories;
compute a respective data matrix of a plurality of data matrices for each subset of features of the workplace behaviour or assessment features associated with each given category, the respective data matrix comprising a plurality of rows each corresponding to one manager and a plurality of columns each corresponding to one feature from the subset of features;
fit a respective machine learning model of a plurality of machine learning models onto the data matrix for each data matrix associated with a respective category, the respective machine learning model comprising a respective coefficient matrix from a plurality of coefficient matrices and a respective component matrix from a plurality of component matrices, wherein:
each coefficient matrix is a nonnegative row vector,
each component matrix is a nonnegative column vector,
each machine learning model is fitted using non-negative matrix factorization, and
each row of each component matrix is associated with a row of the data matrix corresponding to a respective manager and represents a risk index of the respective manager with respect to the respective category;
compute a plurality of category risk indices associated with each respective category and each manager, wherein each category risk index exists on an n-point ordinal scale, and wherein each category risk index is computed based on a respective component matrix value associated with a respective category and a respective manager, and n−1 thresholds; and
compute a global risk index associated with each manager based on a central value of the category risk indices, wherein the global risk index quantifies the risk associated with the manager.
